(19) United States
(12) Patent Application Publication
(10) Pub. No.: US 2015/0125306 A1
(43) Pub. Date: May 7, 2015

(54) Method for Connecting a Shaft to a Rotary Component and Turbocharger Shaft Produced by said Method

(71) Applicant: Robert Bosch GmbH, Stuttgart (DE)

(72) Inventors: Johannes Schmid, Immenstadt (DE); Bernd Reinsch, Ludwigsburg (DE); Ugur Kisa, Immenstadt (DE); Andreas Burghardt, Stuttgart (DE); Jochen Rager, Bisingen (DE); Bernd Lutz, Kempten (DE)

(21) Appl. No.: 14/397,838

(22) PCT Filed: Apr. 3, 2013
(86) PCT No.: PCT/EP2013/056979

§ 371 Date: Oct. 29, 2014

(30) Foreign Application Priority Data
May 2, 2012 (JP) 10 2012 207 271.3

(51) Int. Cl. B21K 1/06; F04D 29/26

(52) U.S. Cl. CPC B21K 1/06; F04D 29/266; F05D 2220/40
USPC 416/198 A; 29/889.2

(57) ABSTRACT

A method for producing a connection of at least one rotary component with a central opening to a shaft with a first section along the shaft and a second section on an end face of the shaft includes fixing the shaft at the first section in the central opening of the at least one rotary component by an eccentric arrangement. The fixing of the shaft is such that the shaft is fixed in the radial direction relative to the at least one rotary component. The method also includes fixing the shaft at the second section by press-fitting a ball so that the shaft is secured in the axial direction relative to the at least one rotary component. The fixing steps are carried about by a positive engagement.

The present invention relates to a method for connecting a shaft to a rotary component, in particular a turbine and/or compressor wheel, and a turbocharger shaft produced by this method.

### STATE OF THE ART

The state of the art discloses methods for connecting a shaft to a turbine wheel and/or a compressor wheel, this method being used, for example, in producing exhaust turbochargers for the automotive sector. Here it is primarily the exhaust-side connection of the shaft to the turbine wheel that is of interest, since the turbine wheel of an exhaust turbocharger is exposed to substantially higher temperatures than the compressor wheel, which has fresh air flowing round it. This connection is therefore of greater interest, since problems with the type of connection can arise due to the generally different materials used for the shaft and the turbine wheel and their respective coefficients of thermal expansion at the relatively high temperatures to which these components are exposed.

DE 10 2010 010 136 A1 discloses a turbocharger shaft having a rotor affixed to it, wherein the shaft and the wheel by means of a straight-knurled edging form a positively interlocking connection, which fixes the shaft in a radial direction relative to the rotor. In an axial direction the shaft is fixed in relation to the rotor by means of a shaft nut, that is to say by means of a non-positive connection.

### DISCLOSURE OF THE INVENTION

In a first aspect according to claim 1 the invention proposes a method for producing a connection of at least one rotary component to a shaft, wherein at least the one rotary component has a central opening and the shaft has at least one first portion along the shaft and a second portion on an end face, wherein the method comprises the following steps: fixing the shaft by its first portion in the central opening of at least the one rotary component, so that the shaft is fixed in a radial direction relative to at least the one rotary component; and fixing the shaft by its second portion, so that the shaft is fixed in an axial direction relative to at least the one rotary component; wherein the fixing steps are each performed in a positively interlocking manner.

In a second aspect according to claim 12 the invention proposes a turbocharger shaft, which is connected to at least one rotary component, wherein the connection between the shaft and the rotary component is performed by the method according to the first aspect.

### Advantages of the Invention

The advantage of the method and of the turbocharger shaft according to one embodiment produced by the method results from the fact that the shaft is only ever fixed relative to the rotary component, that is to say the turbine and/or compressor wheel, by a positively interlocking connection, both in a radial direction and in an axial direction. That is to say the connection between the shaft and/or the compressor wheel is especially easy to produce, making it possible to use materials which owing to their characteristics, such as mechanical machinability and coefficient of thermal expansion, for example, can otherwise be machined only with a relatively large outlay in terms of cost and time.

The step of fixing the shaft by its first portion in the central opening of at least the one rotary component advantageously comprises an eccentric configuration arranged on the first portion, that is to say eccentrically in the circumferential direction of the shaft, wherein the central opening of at least the one rotary component is formed so as to correspond to the eccentric configuration, in such a way that the shaft is fixed by positive interlock in a radial direction by turning the shaft in relation to the central opening. The eccentric configuration of the connection allows the manufacturing tolerances to be relatively larger than is conventional, which reduces costs.

In addition the transmission efficiency in terms of torque is relatively high by virtue of the positively interlocking connection.

Likewise the connection between the shaft and the wheel is moreover self-locking due to the positive interlock of the eccentric configuration, but is also releasable, since the interlock acts only in one direction.

In addition the action of the positively interlocking connection is self-intensifying when the turbocharger is in operation.

Moreover, the connection between the shaft and the wheel is also self-centering.

It is furthermore preferable for the step of fixing the shaft by its second portion to be performed by caulking a ball in a corresponding opening on the one end face of the shaft, so that the shaft is fixed by positive interlock in an axial direction in relation to at least the one rotary component. Such a connection is relatively easy to produce and is cost-effective, particularly in mass production.

The step of fixing the shaft by its first portion in the central opening of at least the one rotary component to be performed is preferably performed by straight-knurled edging, which is arranged on the first portion and which has axially parallel grooves along the shaft, wherein the central opening of at least the one rotary component has a corresponding straight-knurled edging with corresponding grooves, so that in a radial direction the shaft is fixed by positive interlock in relation to the central opening of at least the one rotary component. This type of connection also affords relatively high connective rigidity.

It is furthermore preferable, after caulking of the ball in the opening on the one end face of the shaft, for a closing cover element to be arranged on the end face, wherein the closing cover element comprises a machinable material, so that at least the one rotary component can be balanced by an appropriate working or machining of the closing cover element, which has the advantage that the rotary component need not be machined for balancing purposes.

The shaft is advantageously fixed in relation to at least the one rotary component both by the first portion of the shaft and by the second portion of the shaft together in the central opening, wherein the first portion of the shaft and the second portion of the shaft are arranged substantially in the area of the end face of the shaft. The rotary component therefore does no have to be expensively machined in such a way that the shaft extends right through the rotary component.

The eccentric configuration preferably comprises at least two, preferably three wedge-shaped areas in the circumferential direction of the shaft. Here the wedge-shaped areas preferably each have a taper ratio, viewed in the circumferential direction of the shaft, of between 1:25 and 1:200, which under a rotation of the shaft relative to the rotary component produces a relatively high and secure connective rigidity, and at the same time is also releasable again.

The shaft is preferably fixed by its first portion in the central opening of at least the one rotary component by means of a first and a second clamping sleeve, which are each slit in their longitudinal direction, wherein the first clamping sleeve has an inside diameter which substantially corresponds to the outside diameter of the shaft, and the first clamping sleeve on its outside has at least two wedge-shaped areas in the circumferential direction of the clamping sleeve, and the second clamping sleeve has an inside diameter corresponding to the outside diameter of the first clamping sleeve, wherein the shaft is fixed in relation to the rotary component by arranging the first clamping sleeve on the shaft, and then pushing the second clamping sleeve over the first clamping sleeve, and then turning the first clamping sleeve in relation to the second clamping sleeve by means of suitable shaped formations on each of the clamping sleeves, forming a positive interlock, whilst the first and second clamping sleeve are being arranged together in the central opening of the rotary component, so that the first clamping sleeve is fixed by positive interlock to the shaft and the second clamping sleeve is fixed by positive interlock to the central opening of the rotary component. This type of connection, too, has a relatively high and secure rigidity, and is also releasable again.

It is furthermore preferable for at least the one rotary component to be a turbine wheel and/or a compressor wheel of a turbocharger, wherein the turbine or compressor wheel may preferably be produced from titanium aluminide, which has an especially high strength with at the same time a relatively low weight.

### BRIEF DESCRIPTION OF THE DRAWINGS

The invention is explained below with reference to embodiments and in conjunction with the figures, of which:

FIG. 1 shows a shaft and a turbine wheel according to a first embodiment of the invention;

FIG. 2 shows a shaft and a turbine wheel according to a second embodiment of the invention;

FIG. 3 shows a shaft and a turbine wheel according to a third embodiment of the invention;

FIG. 4 shows a shaft and a turbine wheel according to a fourth embodiment of the invention;

FIGS. 5a and 5b show a shaft and a turbine wheel according to a fifth embodiment of the invention; and

FIGS. 6a and 6b show a shaft and a turbine wheel according to a sixth embodiment of the invention.

### EMBODIMENTS OF THE INVENTION

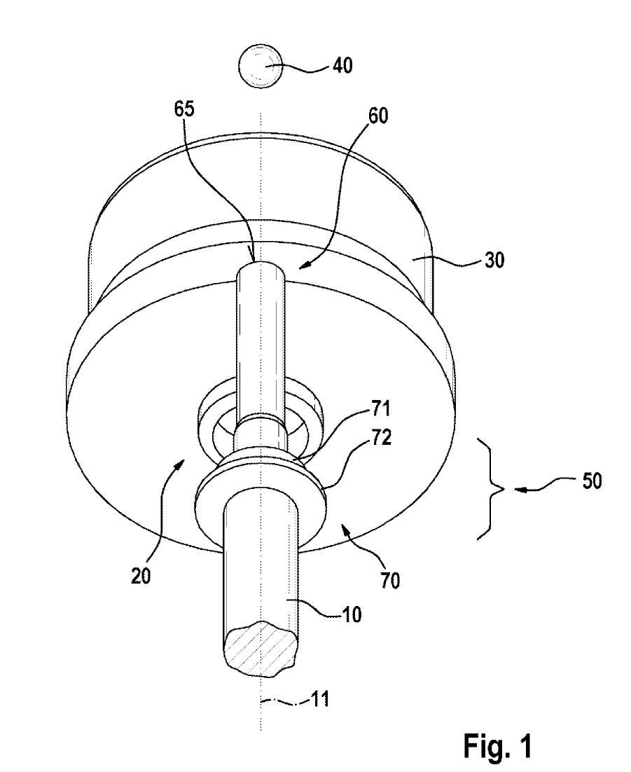

A first embodiment of the invention will now be explained with reference to FIG. 1.

FIG. 1 represents a rather schematic and exploded view of a shaft 10, which—in an initially unconnected way—extends through a central opening 20 of a rotary component 30, which in the example shown is a turbine wheel of a turbocharger (not shown in its entirety) of an internal combustion engine. Also represented in FIG. 1 is a ball 40, the function of which is explained in detail further below.

The arrangement of the components represented in FIG. 1 is selected for the purpose of explaining the steps of the method, so that the components, as already mentioned above, are not yet connected to one another.

The shaft 10 comprises a first portion 50 and a second portion 60, wherein the second portion 60 forms one end of the shaft 10, whilst the second end of the shaft 10 is not shown, since in the representation in FIG. 1 the shaft 10 is interrupted for the sake of greater clarity. In the representation shown in FIG. 1 the shaft 10 would extend further (downward in the drawing in FIG. 1), so that a compressor wheel, for example, could be fixed to its other end. Basically, however, it is of no significance for the method described whether it is a turbine wheel or a compressor wheel.

The first portion 50 of the shaft 10 comprises an eccentric configuration 70, that is to say a projection in the form of an eccentric in relation to the longitudinal axis 11 of the shaft 10, and a collar-shaped stop 72, which adjoins the projection 71 and has a larger diameter than the projection 71.

The central opening 20 corresponds in its inside diameter and its shape to the eccentric projection 71, that is to say the shaft 10 can be introduced in the nature of a clearance fit axially into the opening 20, until the stop 72 bears on the opening 20, and by turning the shaft 10 radially in relation to the opening 20 can be fixed in such a way that the shaft 10 is fixed in a radial direction relative to the turbine wheel 30.

The shaft 10 is fixed or secured in an axial direction relative to the turbine wheel 30 by pressing the ball 40 into an opening (not represented in FIG. 1), which is situated on the second portion 60 of the shaft 10, that is to say on an end face 65 of the shaft 10.

Pressing and caulking the ball 40 into the opening on the second area of the shaft 10 produces a caulked bead, which allows the shaft 10 to be fixed in an axial direction relative to the turbine wheel 30.

Both in a radial direction and in an axial direction, therefore, the shaft 10 is only ever fixed relative to the turbine wheel 30 in a positively interlocking manner.

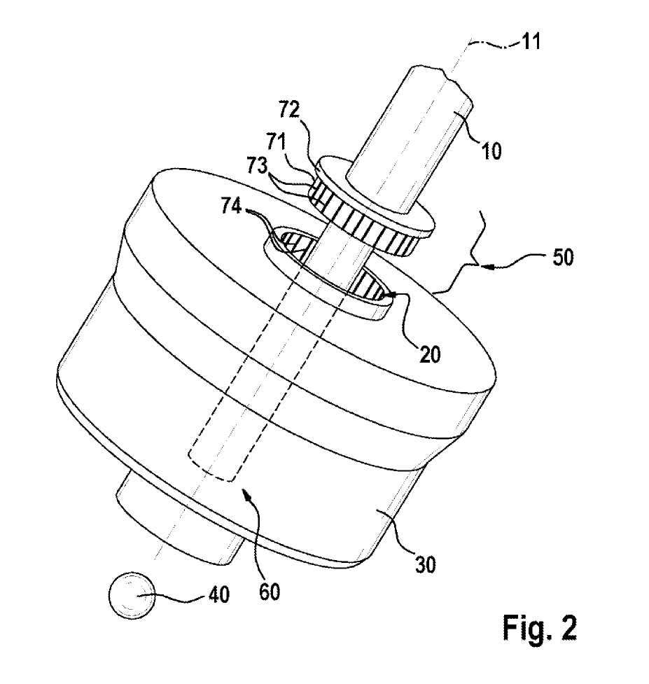

FIG. 2 illustrates a second embodiment of the invention.

Again the components, that is to say the shaft 10, the turbine wheel 30 and the ball 40 are shown in an unconnected state in an exploded view.

This time, however, in contrast to FIG. 1, the first portion 50 comprises a projection 71 formed with longitudinal grooves 73 instead of the eccentrically formed projection. A collar-shaped stop 72 in FIG. 2 substantially corresponds to the stop 72 in FIG. 1.

An opening 20 corresponds, in its diameter and the formation with corresponding grooves 74, to the projection 71 to the projection 71 formed with longitudinal grooves 73, wherein the grooves 74 are complementary to the longitudinal grooves 73 formed on the projection 71.

The shaft 10 is again fixed in relation to the turbine wheel 30 by introducing the first area 50 far enough into the opening 20, until the stop 72 bears on the opening 20, and the grooves 73 engage with a positive interlock in the grooves 74. Consequently the shaft 10 is fixed in a radial direction in relation to the turbine wheel 30.

As stated above with reference to FIG. 1, the shaft 10 in an axial direction is then caulked by means of the ball 40 in an opening (not shown here) arranged in the second portion 60.

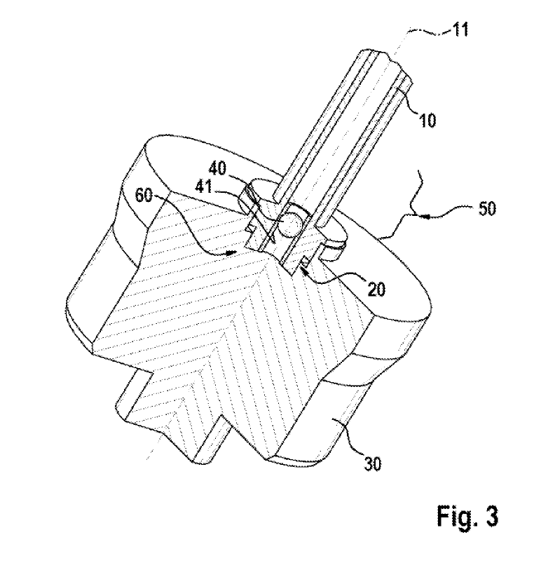

FIG. 3 illustrates a third embodiment of the invention, wherein in contrast to the embodiments shown in FIGS. 1 and 2 the first portion 50 and the second portion 60 of the shaft 10 as it were coincide relative to the longitudinal axis 11 of the shaft 10. Here FIG. 3 already shows the outcome of the method, that is to say the connected state of the shaft 10 with the turbine wheel 30. The particular difference with this embodiment compared to the preceding embodiments is that the shaft 10 does not extend entirely through the turbine wheel 30 but only to the depth of the central opening 20. It is therefore not necessary to bore right through turbine wheel 30.

Otherwise the method of fixing the shaft 10 in relation to the turbine wheel 30 both radially and axially is similar to the embodiments explained with reference to FIGS. 1 and 2. The method of fixing the shaft 10 radially by its first portion 50 in the opening 20 of the turbine wheel 30 can, for example, by way of an eccentric or a straight-knurled edging, that is to say with grooves. The method of fixing the shaft 10 axially by its second portion 60 in relation to the turbine wheel 30 is again done by means of a ball 40, which is caulked in an opening 41, represented in cross section in FIG. 3.

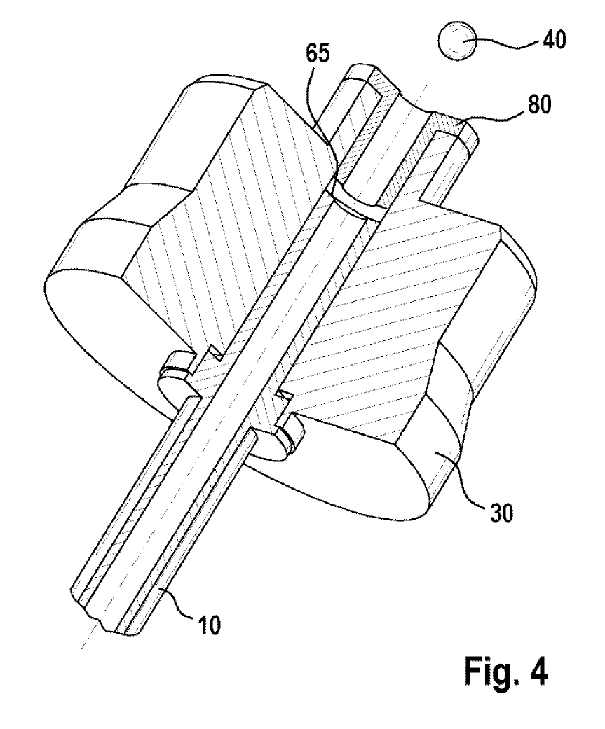

FIG. 4 illustrates a fourth embodiment of the invention, wherein this embodiment substantially corresponds to the embodiments explained with reference to FIGS. 1 and 2, with the difference that a closing cover element 80 is fitted to the end face 65 of the shaft 10.

This closing cover element 80 is made from a material that is relatively easy to machine, so as to facilitate balancing of the arrangement of the shaft 10 with the turbine wheel 30 affixed thereto, since otherwise it could be relatively more difficult to achieve balancing by machining the turbine wheel 30, owing to the relatively hard material of the turbine wheel 30, such as titanium aluminide, for example.

Otherwise the shaft 10 is fixed to the turbine wheel 30 as already explained above.

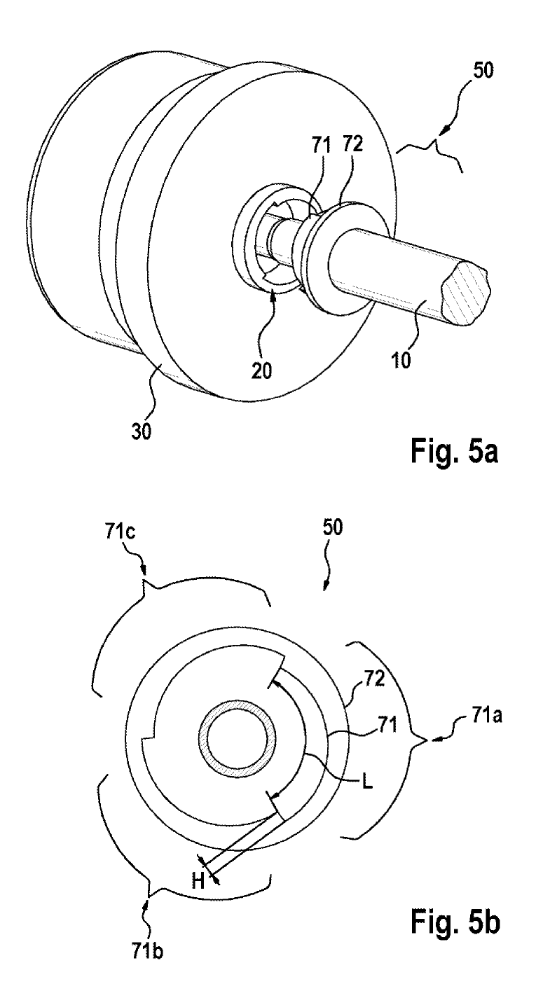

FIGS. 5a and 5b illustrate a fifth embodiment of the invention, wherein this embodiment corresponds soonest to the embodiment explained with reference to FIG. 1.

The essential difference from the embodiment explained with reference to FIG. 1 will be described with reference to FIG. 5b, which shows a cross sectional view of the first portion 50 of the shaft 10 in FIG. 5a.

As can be seen from FIG. 5b, the eccentric projection 71 has three wedge-shaped areas 71a, 71b, 71c, which substantially replace the function of the eccentric in the embodiment with reference to FIG. 1. The taper ratio of these wedge-shaped areas 71a, 71b, 71c, that is to say the ratio of the area length L to the area height H, which in the example represented in FIG. 5b are drawn in for the wedge-shaped area 71a, lies preferably in a range from 1:25 to 1:200, so that a relatively secure, self-locking connection results between the shaft 10 and the turbine wheel 30 when the shaft 10 is turned by the portion 50 in the central opening 20 in relation to the turbine wheel 30, and the shape of the opening 20 is accordingly designed to complement the wedge-shaped areas 71a, 71b, 71c (not represented in FIG. 5a, however).

It is also feasible, however, to provide just two wedge-shaped areas or also more than three wedge-shaped areas, as represented in FIG. 5b.

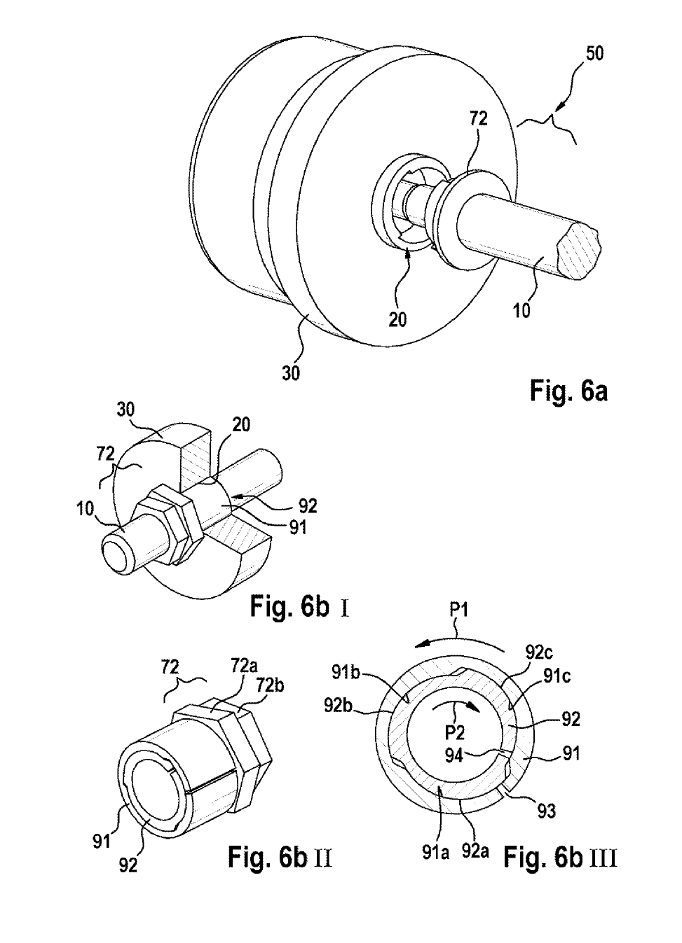

FIGS. 6a and 6b illustrate a sixth embodiment of the invention, wherein this embodiment can be seen as a modification of the embodiment explained with reference to FIGS. 5a and 5b.

The essential difference from the embodiment explained with reference to FIGS. 5a and 5b will be described with reference to FIG. 6b, which consists of three detailed views I, II, III of the first portion 50 of the shaft 10 in FIG. 6a.

As shown in FIG. 6b I the first portion 50 of the shaft 10 comprises two clamping sleeves 91, 92 inserted one inside the other, which together are arranged on the shaft 10. In the example represented in FIG. 6b I the two clamping sleeves 91, 92 are shown as being situated in the central opening 20 of the turbine wheel 30, only a part of the turbine wheel 30 being represented.

FIG. 6b II again shows the two clamping sleeves 91, 92 in isolation, but from another perspective. Here it can be seen, in particular, that the clamping sleeve 92 is arranged inside the clamping sleeve 91, wherein the outside diameter of the clamping sleeve 92 in the nature of a clearance fit is somewhat smaller than the inside diameter of the clamping sleeve 91. The inside diameter of the clamping sleeve 92 is somewhat larger than the outside diameter of the shaft 10. FIG. 6b II also shows that the clamping sleeves 91, 92 each comprise a collar-shaped stop 72a, 72b in the form of a hexagon, which together form the stop 72. The stops 72a, 72b serve for turning the clamping sleeves 91, 92 in opposition to one another by means of an open-ended wrench, for example.

FIG. 6b III finally shows a cross sectional view of the two clamping sleeves 91, 92. It can be seen here firstly that the clamping sleeves 91, 92 each have a slit 93 and 94 respectively, the function of which is yet to be explained. Secondly it can be seen that the clamping sleeve 92 comprises three wedge-shaped areas 92a, 92b, 92c along its outer circumference, similar to the wedge-shaped areas 71a, 71b, 71c in FIG. 5b. The clamping sleeve 91 correspondingly comprises wedge-shaped areas 91a, 91b, 91c formed along its inner circumference to complement the wedge-shaped areas 92a, 92b, 92c of the clamping sleeve 92, similar to the wedge-shaped areas inside the central opening 20 in FIG. 5a (but not represented there).

If the clamping sleeves 91, 92 are now turned in opposition to one another, represented by arrows P1, P2 in FIG. 6b III, whilst the clamping sleeves 91, 92 are being arranged on the shaft 10 and in the central opening 20 of the turbine wheel 30, the interaction of the wedge-shaped areas 91a, 91b, 91c with the wedge-shaped areas 92a, 92b, 92c results in the following: the inside diameter of the clamping sleeve 92 is reduced, since when turned the wedge-shaped areas 91a, 91b, 91c press onto the clamping sleeve 92 and the slit allows a reduction of the inside diameter of the clamping sleeve 92. At the same time the outside diameter of the clamping sleeve 91 increases due to the interaction of the wedge-shaped areas and due the presence of the slit 93, so that the outer circumference of the clamping sleeve 91 presses on the inner circumference of the opening 20 and consequently a positively interlocking connection, fixed in a radial direction and releasable, is produced between the shaft 10 and the turbine wheel 30. The collar-shaped stop 72a here bears on the opening 20.

Fixing in an axial direction is achieved as already explained above with reference to the other embodiments.

1. A method for producing a connection of at least one rotary component to a shaft, the at least one rotary component having a central opening and the shaft having at least one first portion along the shaft and a second portion on an end face of the shaft, the method comprising:
fixing the shaft by the first portion in the central opening of the at least one rotary component so that the shaft is fixed in a radial direction relative to the at least one rotary component; and
fixing the shaft by its the second portion so that the shaft is fixed in an axial direction relative to the at least one rotary component,
wherein the fixing of the shaft by the first portion and the fixing of the shaft by the second are performed in a positively interlocking manner.

2. The method as claimed in claim 1, wherein the fixing of the shaft by the first portion in the central opening of the at least one rotary component is performed eccentrically in the circumferential direction of the shaft by an eccentric configuration arranged on the first portion, and wherein the central opening of the at least one rotary component is formed so as to correspond to the eccentric configuration, so that the shaft is fixed by positive interlock in a radial direction by turning the shaft in relation to the central opening.

3. The method as claimed in claim 1, wherein the fixing of the shaft by the second portion is performed by caulking a ball in a corresponding opening on the one end face of the shaft so that the shaft is fixed by positive interlock in an axial direction in relation to the at least the one rotary component.

4. The method as claimed in claim 1, wherein the fixing of the shaft by its the first portion in the central opening of the at least one rotary component is performed by a straight-knurled edging, which is arranged on the first portion and which has axially parallel grooves along the shaft, and wherein the central opening of the at least the one rotary component has a corresponding straight-knurled edging with grooves so that in a radial direction the shaft is fixed by positive interlock in relation to the central opening of the at least one rotary component.

5. The method as claimed in claim 3, wherein after caulking of the ball in the opening on the one end face of the shaft, a closing cover element is arranged on the end face, and wherein the closing cover element comprises a machinable material so that the at least one rotary component is configured to be balanced by an appropriate working of the closing cover element.

6. The method as claimed in claim 1, wherein the shaft is fixed in relation to the at least one rotary component by the first portion of the shaft and by the second portion of the shaft together in the central opening, and wherein the first portion of the shaft and the second portion of the shaft are arranged substantially in the area of the end face of the shaft.

7. The method as claimed in claim 2, wherein the eccentric configuration comprises three wedge-shaped areas in the circumferential direction of the shaft.

8. The method as claimed in claim 7, wherein the wedge-shaped areas each have a taper ratio of between 1:25 and 1:200 in the circumferential direction of the shaft.

9. The method as claimed in claim 1, wherein the shaft is fixed by the first portion in the central opening of the at least one rotary component by a first clamping sleeve and a second clamping sleeve, the first clamping sleeve and the second clamping sleeve each having a slit in a respective longitudinal direction, wherein the first clamping sleeve has an inside diameter that substantially corresponds to the outside diameter of the shaft, and wherein the first clamping sleeve on its outside has three wedge-shaped areas extending in its circumferential direction, and the second clamping sleeve has an inside diameter corresponding to the outside diameter of the first clamping sleeve, wherein the shaft is fixed in relation to the rotary component by arranging the first clamping sleeve on the shaft, pushing the second clamping sleeve over the first clamping sleeve, and turning the first clamping sleeve in relation to the second clamping sleeve by suitable shaped formations on each of the clamping sleeves, forming a positive interlock, wherein the first clamping sleeve and the second clamping sleeve are arranged together in the central opening of the rotary component so that the first clamping sleeve is fixed by positive interlock to the shaft and the second clamping sleeve is fixed by positive interlock to the central opening of the rotary component.

10. The method as claimed in claim 1, wherein the at least one rotary component is one or more of a turbine wheel and a compressor wheel of a turbocharger.

11. The method as claimed in claim 10, wherein the at least one rotary component is made from titanium aluminide.

12. A turbocharger shaft connected to at least one rotary component, the connection between the shaft and the rotary component being performed according to a method including:
fixing a first portion of the shaft in a central opening of the at least one rotary component so that the shaft is fixed in a radial direction relative to the at least one rotary component; and
fixing a second portion of the shaft so that the shaft is fixed in an axial direction relative to the at least one rotary component,
wherein the fixing of the shaft by the first portion and the fixing of the shaft by the second are performed in a positively interlocking manner.

13. The method as claimed in claim 5, wherein the at least one rotary component is configured to be balanced by an appropriate machining of the closing cover element.
